(19) United States
(12) Patent Application Publication
(10) Pub. No.: US 2021/0010518 A1
(43) Pub. Date: Jan. 14, 2021

(54) CONNECTION PAIR FOR SYMMETRIC BIDIRECTIONAL TAPERED THREAD IN OLIVE-LIKE SHAPE

(71) Applicant: AMICUS VERITATIS MACHINERY CO., LTD., TAIZHOU (CN)

(72) Inventor: Yihua YOU, TAIZHOU (CN)

(21) Appl. No.: 17/034,319

(22) Filed: Sep. 28, 2020

Related U.S. Application Data
(63) Continuation of application No. PCT/CN2019/081380, filed on Apr. 4, 2019.

(30) Foreign Application Priority Data
Apr. 7, 2018 (CN) 201810303100.X

(51) Int. Cl. F16B 35/04

(52) U.S. Cl. CPC F16B 35/041

(57) ABSTRACT

The present disclosure belongs to the field of general technology of device, and particularly relates to a connection pair for a symmetric bidirectional conical thread in an olive-like shape, which solves the problems such as poor self-positioning and self-locking properties of a screw thread in the prior art. The symmetric bidirectional tapered thread connection pair is characterized in that an internal thread (6) is a bidirectional tapered hole (41) (a non-entity space) in an internal surface of a cylindrical body (2), an external thread (9) is a bidirectional truncated cone body (71) in an external surface of a columnar body (3), and each of the complete unit threads thereof is a bidirectional tapered body in an olive-like shape (93), with a large middle and two small ends and the same and/or approximately the same size in a left taper (95) and a right taper (96).

### CROSS-REFERENCE TO RELATED APPLICATIONS

This application is a continuation of International Patent Application No. PCT/CN2019/081380, filed on Apr. 4, 2019, entitled “Connection Pair for Symmetric Bidirectional Tapered Thread in Olive-Like Shape” which claims priority to China Patent Application No. 2018103030100.X, filed on Apr. 7, 2018. The contents of these identified applications are hereby incorporated by references.

### TECHNICAL FIELD

The present invention belongs to the field of general technology of device, and particularly relates to a connection pair for a symmetric bidirectional tapered thread in an olive-like shape.

### BACKGROUND OF THE INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same tooth profile and continuously protruding along a helical line on a cylindrical or conical surface; and the “tooth body” refers to a material entity between adjacent flanks. This is also the definition of thread under global consensus.

The modern thread began in 1841 with British Whitworth thread. According to theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder, and the flatter the inclined plane is, the greater the mechanical advantage is (see FIG. 8) (Jingshan Yang and Xiuya Wang, Discussion on the Principle of Screws, Disquisitiones Arithmeticae of Gauss).

The “principle of inclined plane” of the modern thread is an inclined plane slider model (see FIG. 9) which is established based on the law of inclined plane. It is believed that the thread pair meets the requirements of self-locking when a thread rise angle is less than or equal to the equivalent friction angle under the condition of little change of static load and temperature. The thread rise angle (see FIG. 10), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

The modern threads are abundant in types and forms, and are all tooth-shaped threads, which are determined by the technical principle, i.e., the principle of inclined plane. Specifically, the thread formed on a cylindrical surface is called cylindrical thread; the thread formed on a conical surface is called conical thread; and the thread formed on an end surface of the cylinder or the truncated cone is called plane thread. The thread formed on the surface of an outer circle of the body is called external thread; the thread formed on the surface of an inner round hole of the body is called internal thread; and the thread formed on the end surface of the body is called end face thread. The thread that the helical direction and the thread rise angle direction conform to the left-hand rule is called left-hand thread; and the thread that the helical direction and the thread rise angle direction conform to the right-hand rule is called right-hand thread. The thread having only one helical line in the same cross section of the body is called single-start thread; the thread having two helical lines is called double-start thread; and the thread having multiple helical lines is called multi-start thread. The thread having a triangular cross section is called triangular thread; the thread having a trapezoidal cross section is called trapezoidal thread; the thread having a rectangular cross section is called rectangular thread; and the thread having a sawtooth cross section is called sawtooth thread.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a connection pair for a symmetric bidirectional tapered thread in an olive-like shape with reasonable design, simple structure, and excellent connection performance and locking performance with respect to the above problems.

In order to achieve the above objective, the present invention adopts the following technical solution. The symmetric bidirectional tapered thread connection pair in an olive-like shape is composed of a symmetric bidirectional tapered external thread and a symmetric bidirectional tapered internal thread. It is a special thread pair technology that combines technical characteristics of a cone pair and a helical movement. A bidirectional tapered thread is a thread technology that combines technical characteristics of a bidirectional tapered body and a helical structure. The bidirectional tapered body is composed of two unidirectional tapered bodies, wherein the two unidirectional tapered bodies are located on the left side and the right side of the bidirectional tapered body respectively, that is, the bidirectional tapered body is bidirectionally composed of two unidirectional tapered bodies which are opposite in directions of a left taper and a right taper and the same and/or approximately the same size in the left taper and the right taper. The external thread is formed in such a way that the bidirectional tapered body is helically distributed on the external surface of the columnar body and/or the internal thread is formed in such a way that the bidirectional tapered body is helically distributed on the internal surface of the cylindrical body. Regardless of the internal thread and the external thread, the complete unit thread is a special bidirectional tapered geometry in an olive-like shape, with a large middle and two small ends, and the same and/or approximately the same size in the left taper and the right taper.

According to the symmetric bidirectional tapered thread connection pair in an olive-like shape, the definition of the symmetric bidirectional tapered thread in an olive-like shape may be expressed as follows: “symmetric bidirectional tapered holes (symmetric bidirectional truncated cone bodies) which have defined left taper and right taper as well as are opposite in directions of the left taper and the right taper and are the same and/or approximately the same size in the left taper and the right taper and special bidirectional helical tapered geometries in an olive-like shape that are continuously and/or non-continuously distributed along the helical line and have a large middle and two small ends respectively are arranged on a columnar surface or conical surface”. Due to manufacturing reasons, heads and tails of the symmetric bidirectional tapered threads may be incomplete bidirectional tapered geometries. Different from the existing screw thread technology, in terms of the number of complete unit threads and/or incomplete unit threads, the number of the bidirectional tapered threads is not based on the “number of threads”, but based on the “number of pitches”, that is, is not called several threads of screw threads, but called several pitches of screw threads. The change in the number of the screw threads is based on the change in the meaning of the screw thread technology. The thread technology has changed from the cohesion relationship between the internal thread and the external thread in the modern thread to the cohesion relationship between the internal thread and the external thread in the bidirectional tapered thread.

The symmetric bidirectional tapered thread connection pair in an olive-like shape includes a bidirectional truncated cone body helically distributed on the external surface of the columnar body and a bidirectional tapered hole helically distributed on the internal surface of the cylindrical body, that is, includes an external thread and an internal thread in mutual thread fit, wherein the internal thread is provided with a bidirectional helical tapered hole and exists in the form of a “non-entity space”, and the external thread is provided with a bidirectional helical truncated cone body and exists in the form of a “material entity”. The non-entity space refers to a space environment capable of accommodating the above-mentioned material entity. The internal thread is a housing member, and the external thread is a housed member. A working state of the screw thread is described as follows: the internal thread and the external thread are bidirectional tapered geometries screwed and sleeved together, and the internal thread and the external thread are cohered until single-side bidirectional load bearing or left and right bidirectional load bearing or until the sizing interference fit. Whether bidirectional load bearing is achieved on two sides simultaneously is related to the actual working conditions of the application field, that is, the bidirectional tapered hole houses and engages the bidirectional truncated cone body by pitches, that is, the internal thread engages the corresponding external thread by pitches.

The thread connection pair is characterized in that a helical external conical surface and a helical internal conical surface are cooperated to constitute a cone pair to form a thread pair. The external conical surface of the external cone and the internal conical surface of the internal cone of the bidirectional tapered thread are both bidirectional conical surfaces. When the thread connection pair is formed between the bidirectional conical threads, the joint surface of the internal conical surface and the external conical surface is used as a bearing surface, that is, the conical surface is used as the bearing surface to achieve the connecting performance. Self-locking property, self-positioning property, reusability, fatigue resistance and other capabilities of the thread pair mainly depend on the conical surface and the taper size of the cone pair constituting the symmetric bidirectional tapered thread connection pair in an olive-like shape, that is, depends on the conical surface and its taper size of the internal thread and the external thread. The symmetric bidirectional tapered thread connection pair in an olive-like shape is a non-form thread.

Different from that the principle of inclined plane of the existing thread which shows a unidirectional force distributed on the inclined plane as well as a cohesion relationship between the internal tooth bodies and the external tooth bodies of the internal thread and the external thread, the bidirectional tapered body of the symmetric bidirectional tapered thread connection pair in an olive-like shape is composed of two plain lines of the cone body in two directions (i.e. bidirectional state) when viewed from any cross section of the single tapered body distributed on either left or right side along the cone axis. The plain line is the intersection line of the conical surfaces and a plane through which the cone axis passes through. The cone principle of the symmetric bidirectional tapered thread connection pair in an olive-like shape shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone body) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair, composed of the internal thread and the external thread in the traditional thread, which realizes its connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the internal conical surface of the internal cone body is cohered with the external conical surface of the external cone body; and the internal conical surface is in close contact with the external conical surface. The axial force of the internal cone and the counter-axial force of the external cone are concepts of forces unique to the bidirectional tapered thread technology, i.e., the cone pair technology, in the present invention.

The internal cone body exists in a form similar to a shaft sleeve, and generates the axial force pointing to or pressing toward the cone axis under the action of an external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and/or approximately reversely collinear when the cone body and the helical structure are combined into the thread and form the thread pair. The internal cone and the external cone are cohered till interference is achieved, so the axial force and the counter-axial force generate a pressure on the contact surface between the internal conical surface and the external conical surface and are densely and uniformly distributed on the contact surface between the internal conical surface and the external conical surface axially and circumferentially. When the cohesion movement of the internal cone and the external cone continues till the cone pair reaches the pressure generated by interference fit to combine the internal cone with the external cone, i.e., the pressure enables the internal cone body to be cohered with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. However, not any axial force angle and/or counter-axial force angle may enable the cone pair to produce self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation until the cone pair completely has no self-locking ability, and the axial bearing capacity changes in a direction of enhancement until the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation until the cone pair is close to have has no self-positioning ability at all.

Compared with the technology with the housing and housed relationship of irreversible one-sided bidirectional housing that the unidirectional tapered thread of a single cone body invented by the applicant before which can only bear the load by one side of the conical surface, the thread connection pair of the bidirectional tapered thread technology of the present disclosure allows the reversible left and right-sided bidirectional housing of the bidirectional tapered threads of double cone bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the symmetric bidirectional tapered thread connection pair to obtain a necessary ordered degree of freedom, thereby effectively combining the technical characteristics of the cone pair and the thread pair to form a brand-new thread technology.

When the symmetric bidirectional tapered thread connection pair in an olive-like shape is used, the bidirectional conical surface of the truncated cone body of the external thread of the bidirectional tapered thread matches with the bidirectional conical surface of the tapered hole of the internal thread of the bidirectional tapered thread.

The bidirectional tapered body, that is, the truncated cone body, constituting the symmetric bidirectional tapered thread connection pair in an olive-like shape and/or the tapered hole may achieve the self-locking property and/or the self-positioning property of the thread connection pair, rather than any taper or any taper angle. The symmetric bidirectional tapered thread connection pair may have self-locking and self-positioning properties as long as the internal cone and the external cone of the bidirectional tapered body must reach a certain taper or a certain taper angle. The tapers include left tapers and right tapers of an internal thread body and an external thread body, and the taper angles include left taper angles and right taper angles of the internal thread body and the external thread body. The left tapers correspond to the left taper angles, that is, the first taper angle α1, preferably, the first taper angle α1 is greater than 0° and less than 53°, preferably, the first taper angle α1 takes a value in a range from 2° to 40°. The right tapers correspond to the right taper angles, that is, the second taper angle α2, preferably, the second taper angle α2 is greater than 0° and less than 53°, and the second taper angle α2 takes a value in a range from 2° to 40°. For individual special fields, preferably, the first taper angle α1 is greater than or equal to 53° and less than 180°, the second taper angle α2 is greater than or equal to 53° and less than 180°, preferably, the first taper angle α1 and the second taper angle α2 take values in a range from 53° to 90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

According to the symmetric bidirectional tapered thread connection pair in an olive-like shape, the external thread is arranged on the external surface of the columnar body, wherein a helically distributed truncated cone body including a symmetric bidirectional truncated cone body in an olive-like shape is disposed on the external surface of the columnar body, and the columnar body may be solid or hollow, including columnar and/or non-columnar workpieces and objects that need to be machined with screw threads on their external surfaces. The external surfaces include columnar surfaces, non-columnar surfaces such as conical surfaces, and external surfaces of other geometric shapes.

According to the symmetric bidirectional tapered thread connection pair in an olive-like shape, the symmetric bidirectional truncated cone body, that is, the external thread, is characterized by being formed by symmetrically and oppositely joining lower bottom surfaces of the two same truncated cone bodies in a helical form, and upper top surfaces are disposed on two ends of the bidirectional truncated cone bodies to form the symmetric bidirectional tapered thread in an olive-like shape, and the process includes that the upper top surfaces are respectively fitted with upper top surfaces of adjacent bidirectional truncated cone bodies and/or respectively fitted with upper top surfaces of adjacent bidirectional truncated cone bodies in a helical form. The symmetric bidirectional tapered external thread in an olive-like shape includes a first helical conical surface of the truncated cone body, a second helical conical surface of the truncated cone body, and an external helical line. Within a cross section passing through the thread axis, the complete single-pitch symmetric bidirectional tapered external thread is a special bidirectional tapered geometry in an olive-like shape, with a large middle and two small ends, and the same and/or approximately the same size in the left taper and the right taper. The symmetric bidirectional truncated cone body includes a bidirectional conical surface of the truncated cone body, wherein an included angle between two plain lines of a left conical surface, that is, the first helical conical surface of the truncated cone body is a first taper angle α1, and the first helical conical surface of the truncated cone body forms the left taper and is in a leftward distribution; and an included angle α2 between two plain lines of a right conical surface, that is, the second helical conical surface of the truncated cone body is a second taper angle α2, and the second helical conical surface of the truncated cone body forms the right taper and is in a rightward distribution. Taper directions corresponding to the first taper angle α1 and the second taper angle α2 are opposite, and the plain lines are intersecting lines of the conical surface with the plane passing through the cone axis. A shape formed by the first helical conical surface of the truncated cone body and the second helical conical surface of the truncated cone body of the bidirectional truncated cone body is the same as a shape of an external helical lateral surface of a rotary body, wherein the rotary body is formed by two inclined sides of a right-angled trapezoid union when the right-angled trapezoid union axially moves at a constant speed along a central axis of the columnar body while circumferentially rotating at a constant speed with right-angled sides of the right-angled trapezoid union as a rotation center, wherein the right-angled trapezoid union is formed by symmetrically and oppositely joining lower bottom sides of two same right-angled trapezoids, wherein the right-angled trapezoids coincide with the central axis of the columnar body 2. The right-angled trapezoid union refers to a special geometry in which the lower bottom sides of the two same right-angled trapezoids are symmetrically and oppositely joined and the upper bottom sides thereof are respectively located at two ends of the right-angled trapezoid union.

According to the symmetric bidirectional tapered thread connection pair in an olive-like shape, the internal thread is arranged on the internal surface of the cylindrical body, wherein a helically distributed tapered hole including a symmetric bidirectional tapered hole in an olive-like shape is provided in the internal surface of the cylindrical body. The cylindrical body includes cylindrical workpieces and objects and/or non-cylindrical workpieces and objects that need to be machined with internal threads on their internal surfaces, and the internal surfaces include cylindrical surfaces and non-cylindrical surfaces such as conical surfaces.

According to the symmetric bidirectional tapered thread connection pair in an olive-like shape, the symmetric bidirectional tapered hole, that is, the internal thread is characterized by being formed by symmetrically and oppositely joining lower bottom surfaces of the two same tapered holes in a helical form, and upper top surfaces are disposed on two ends of the bidirectional tapered holes to form the symmetric bidirectional tapered thread in an olive-like shape, and the process includes that the upper top surfaces are respectively fitted with upper top surfaces of adjacent bidirectional tapered holes and/or respectively fitted with upper top surfaces of adjacent bidirectional tapered holes in a helical form. The symmetric bidirectional tapered internal thread in an olive-like shape includes a first helical conical surface of the tapered hole, a second helical conical surface of the tapered hole, and an internal helical line. Within the section passing through the thread axis, the complete single-pitch symmetric bidirectional tapered internal thread is a special bidirectional tapered geometry in an olive-like shape, with a large middle and two small ends, and the same and/or approximately the same size in the left taper and the right taper. The symmetric bidirectional tapered hole includes a bidirectional conical surface of the tapered hole, wherein an included angle between two plain lines of a left conical surface (that is, the first helical conical surface of the tapered hole) is a first taper angle α1, and the first helical conical surface of the tapered hole forms the left taper and is in a leftward distribution; and an included angle between two plain lines of a right conical surface (that is, the second helical conical surface of the tapered hole) is a second taper angle α2, and the second helical conical surface of the tapered hole forms the right taper and is in a rightward distribution. Taper directions corresponding to the first taper angle α1 and the second taper angle α2 are opposite, and the plain lines are intersecting lines of the conical surface with the plane passing through the cone axis. A shape formed by the first helical conical surface of the tapered hole and the second helical conical surface of the tapered hole of the bidirectional tapered hole is the same as a shape of an external helical lateral surface of a rotary body, wherein the rotary body is formed by two inclined sides of a right-angled trapezoid union when the right-angled trapezoid union axially moves at a constant speed along a central axis of the cylindrical body while circumferentially rotating at a constant speed with right-angled sides of the right-angled trapezoid union as a rotation center, wherein the right-angled trapezoid union is formed by symmetrically and oppositely joining lower bottom sides of two same right-angled trapezoids, wherein the right-angled trapezoids coincide with the central axis of the cylindrical body. The right-angled trapezoid union refers to a special geometry in which the lower bottom sides of the two same right-angled trapezoids are symmetrically and oppositely joined and the upper bottom sides thereof are respectively located at two ends of the right-angled trapezoid union.

In the above-mentioned symmetric bidirectional tapered thread connection pair in an olive-like shape, there are connection forms such as sharp corners and/or non-sharp corners at the junction of two adjacent helical conical surfaces of the external thread and the junction of two adjacent helical conical surfaces of the internal thread. The sharp corners refer to structural forms without being specially treated with the non-sharp corners relative to the non-sharp corners.

In the above-mentioned symmetric bidirectional tapered thread connection pair in an olive-like shape, when the sharp corner serves as the connection form, an external sharp corner structure is adopted as the connection form at a junction between the first helical conical surface of the truncated cone body and the second helical conical surface of the truncated cone body of the same helix, that is, at a major diameter of the external thread, and an external helical line helically distributed is formed. An internal sharp corner structure is adopted as the connection form at a junction between the first helical conical surface of the truncated cone body of the bidirectional truncated cone body and the second helical conical surface of the truncated cone body of an adjacent bidirectional truncated cone body of the same helix and/or a junction between the second helical conical surface of the truncated cone body of the bidirectional truncated cone body and the first helical conical surface of the truncated cone body of an adjacent bidirectional truncated cone body of the same helix, that is, at a minor diameter of the external thread, and an external helical line helically distributed is formed. An internal sharp corner structure is adopted as the connection form at a junction between the first helical conical surface of the tapered hole and the second helical conical surface of the tapered hole of the bidirectional tapered hole of the same helix, that is, at a major diameter of the internal thread, and an internal helical line helically distributed is formed. An internal sharp corner structure is adopted as the connection form at a junction between the first helical conical surface of the tapered hole of the bidirectional tapered hole and the second helical conical surface of the tapered hole of an adjacent bidirectional tapered hole of the same helix and/or a junction between the second helical conical surface of the tapered hole of the bidirectional tapered hole and the first helical conical surface of the tapered hole of an adjacent bidirectional tapered hole of the same helix, that is, at a minor diameter of the external thread, and an internal helical line helically distributed is formed. The screw thread is compact in structure, relatively high in strength and large in load bearing capability, and has good mechanical connecting, locking and sealing performances, and relatively large physical space for tapered thread machining.

In the above-mentioned symmetric bidirectional tapered thread connection pair in an olive-like shape, when the non-sharp corner serves as the connection form, a non-external sharp corner structure is adopted as the connection form at a junction between the first helical conical surface of the truncated cone body and the second helical conical surface of the truncated cone body of the bidirectional truncated cone body of the same helix, that is, at a major diameter of the external thread, and an external helical structure helically distributed or being of a flat top or arc is formed. A non-internal sharp corner structure is adopted as the connection form at a junction between the first helical conical surface of the truncated cone body of the bidirectional truncated cone body and the second helical conical surface of the truncated cone body of an adjacent bidirectional truncated cone body of the same helix and/or a junction between the second helical conical surface of the truncated cone body of the bidirectional truncated cone body and the first helical conical surface of the truncated cone body of an adjacent bidirectional truncated cone body of the same helix, that is, at a minor diameter of the external thread, and an external helical structure helically distributed or being of a groove or arc is formed. A non-internal sharp corner structure is adopted as the connection form at a junction between the first helical conical surface of the tapered hole and the second helical conical surface of the tapered hole of the bidirectional tapered hole of the same helix, that is, at a major diameter of the internal thread, and an internal helical structure helically distributed or being of a groove or arc is formed. A non-internal sharp corner structure is adopted as the connection form at a junction between the first helical conical surface of the tapered hole of the bidirectional tapered hole and the second helical conical surface of the tapered hole of an adjacent bidirectional tapered hole of the same helix and/or a junction between the second helical conical surface of the tapered hole of the bidirectional tapered hole and the first helical conical surface of the tapered hole of an adjacent bidirectional tapered hole of the same helix, that is, at a minor diameter of the external thread, and an internal helical structure helically distributed or being of a flat top or arc is formed. The non-external sharp corner refers to a geometrical shape such as a plane or an arc in cross section, and the non-internal sharp corner refers to a geometrical shape such as a groove or arc in cross section. Accordingly, the interference is avoided when the internal thread and the external thread are screwed. Oil and dirt may be stored. Depending on the actual application, the groove or arc structure is adopted as the connection form at the minor diameter of the external thread and the major diameter of the internal thread while the sharp corner structure is adopted as the connection form at the major diameter of the external thread and the minor diameter of the internal thread and/or the plane or arc structure is adopted as the connection form at the major diameter of the external thread and the minor diameter of the internal thread while the sharp corner structure is adopted as the connection form at the minor diameter of the external thread and the major diameter of the internal thread and/or the groove or arc structure is adopted as the connection form at the minor diameter of the external thread and the major diameter of the internal thread while the plane or are structure is adopted as the connection form at the major diameter of the external thread and the minor diameter of the internal thread.

When the symmetric bidirectional tapered thread connection pair in an olive-like shape is in transmission connection, bidirectional load bearing is achieved by the screw connection of the bidirectional tapered internal thread (that is, the bidirectional tapered hole) and the bidirectional tapered external thread (that is, the bidirectional truncated cone body). There must be a clearance between the bidirectional tapered external thread and the bidirectional tapered internal thread. If there is oil and other mediums for lubrication between the internal thread and the external thread, it will easily form a load bearing oil film. The clearance is conducive to the formation of the load bearing oil film. The symmetric bidirectional tapered thread connection pair in an olive-like shape is applied in transmission connection, which is equivalent to a group of sliding bearing pairs composed of one pair and/or several pairs of sliding bearings, that is, each pitch of the bidirectional tapered internal thread bidirectionally houses the corresponding pitch of the bidirectional tapered external thread to form a pair of sliding bearings, the number of the sliding bearings formed is adjusted according to the application conditions, that is, the number of the pitches of the housing screw threads and the housed screw threads for the effective bidirectional joint (that is, the effective bidirectional contact cohesion) of the bidirectional tapered internal thread and the bidirectional tapered external thread is designed according to the application conditions. Through bidirectional housing of the bidirectional tapered holes for the bidirectional truncated cone bodies and positioning in multiple directions such as radial, axial, angular, and circumferential directions, preferably, through housing of the bidirectional tapered holes for the bidirectional truncated cone bodies and positioning of the internal cone and the external cone in multiple directions, which is formed by main positioning in radial and circumferential directions and auxiliary positioning in axial and angular directions until the bidirectional conical surface of the tapered hole and the bidirectional conical surface of the truncated cone body are cohered to achieve the self-positioning or until the sizing interference contact to achieve the self-locking, a special composition technology of the cone pair and the thread pair is constituted, so as to ensure the transmission connection accuracy, efficiency and reliability of the tapered thread technology, especially the connection pair for the symmetric bidirectional tapered thread.

When the symmetric bidirectional tapered thread connection pair in an olive-like shape is in fastened and sealed connections, technical performances such as connecting performance, locking capability, anti-loosening property, load bearing capability and sealing property are achieved by the screw connection of the bidirectional tapered holes and the bidirectional truncated cone bodies, that is, the first helical conical surface of the truncated cone body and the first helical conical surface of the tapered hole are sized until the interference and/or the second helical conical surface of the truncated cone body and the second helical conical surface of the tapered hole are sized until the interference. Load bearing in one direction and/or in two directions simultaneously are/is achieved according to the application conditions, that is, the bidirectional truncated cone body and the bidirectional tapered hole achieve that internal and external diameters of the internal cone and the external cone are centralized under the guidance of the helical line until the first helical conical surface of the tapered hole and the first helical conical surface of the truncated cone body are cohered to achieve load bearing in one direction or in two directions simultaneously and the sizing fit or until the sizing interference contact and/or the second helical conical surface of the tapered hole and the second helical conical surface of the truncated cone body are cohered to achieve load bearing in one direction or in two directions simultaneously and the sizing fit or until the sizing interference contact. Through bidirectional housing of the bidirectional internal cone for the bidirectional external cone and positioning in multiple directions such as radial, axial, angular, and circumferential directions, preferably, through housing of the bidirectional tapered holes for the bidirectional truncated cone bodies and positioning of the internal cone and the external cone in multiple directions, which is formed by main positioning in radial and circumferential directions and auxiliary positioning in axial and angular directions until the bidirectional conical surface of the tapered hole and the bidirectional conical surface of the truncated cone body are engage to achieve the self-positioning or until the sizing interference contact to achieve the self-locking, a special composition technology of the cone pair and the thread pair is constituted, so as to achieve the technical performances such as connecting performance, locking capability, anti-loosening property, load bearing capability and sealing property of a mechanical structure.

Accordingly, the technical performances such as transmission accuracy and efficiency, load bearing capability, self-locking force, anti-loosening capability and sealing property of the symmetric bidirectional tapered thread connection pair in an olive-like shape are related to the first helical conical surface of the truncated cone body and the left taper (that is, the first taper angle α1) formed therefrom and the second helical conical surface of the truncated cone body and the right taper (that is, the second taper angle α2) formed therefrom as well as the first helical conical surface of the tapered hole and the left taper (that is, the first taper angle α1) formed therefrom and the second helical conical surface of the tapered hole and the right taper (that is, the second taper angle α2) formed therefrom. The friction coefficient, the processing quality and the application conditions of a material of which the columnar body and the cylindrical body are made have a certain influence on the cone fit.

In the above-mentioned symmetric bidirectional tapered thread connection pair in an olive-like shape, when the right-angled trapezoid union makes one revolution at a constant speed, a distance that the right-angled trapezoid union axially moves is equal to at least one times the sum of lengths of right-angled sides of the two same right-angled trapezoids. This structure ensures that the first helical conical surface of the truncated cone body and the second helical conical surface of the truncated cone body as well as the first helical conical surface of the tapered hole and the second helical conical surface of the tapered hole are enough in length, thereby ensuring enough effective contact area and strength when the bidirectional conical surface of the truncated cone body matches with the bidirectional conical surface of the tapered hole, as well as the efficiency required for the helical movement.

In the above-mentioned symmetric bidirectional tapered thread connection pair in an olive-like shape, when the right-angled trapezoid union makes one revolution at a constant speed, a distance that the right-angled trapezoid union axially moves is equal to the sum of lengths of right-angled sides of the two same right-angled trapezoids. This structure ensures that the first helical conical surface of the truncated cone body and the second helical conical surface of the truncated cone body as well as the first helical conical surface of the tapered hole and the second helical conical surface of the tapered hole are enough in length, thereby ensuring enough effective contact area and strength when the bidirectional conical surface of the truncated cone body matches with the bidirectional conical surface of the tapered hole, as well as the efficiency required for the helical movement.

In the above-mentioned symmetric bidirectional tapered thread connection pair in an olive-like shape, the first helical conical surface of the truncated cone body and the second helical conical surface of the truncated cone body are both continuous helical surfaces or non-continuous helical surfaces. The first helical conical surface of the tapered hole and the second helical conical surface of the tapered hole are both continuous helical surfaces or non-continuous helical surfaces. Preferably, the first helical conical surface of the truncated cone body and the second helical conical surface of the truncated cone body as well as the first helical conical surface of the tapered hole and the second helical conical surface of the tapered hole here are all continuous helical surfaces.

In the above-mentioned symmetric bidirectional tapered thread connection pair in an olive-like shape, one end and/or two ends of the columnar body may be one or two screwing ends screwed into a connecting hole of the cylindrical body, and a contact surface of the first helical conical surface of the truncated cone body and the first helical conical surface of the tapered hole is a bearing surface and/or the first helical conical surface of the truncated cone body and the first helical conical surface of the tapered hole are in interference fit and/or a contact surface of the second helical conical surface of the truncated cone body and the second helical conical surface of the tapered hole is a bearing surface and/or the second helical conical surface of the truncated cone body and the second helical conical surface of the tapered hole are in interference fit. Here, taper directions corresponding to an included angle (that is, a first taper angle) of two plain lines of the left conical surface (that is, the first helical conical surface) of the internal thread and/or the external thread and an included angle (that is, a second taper angle) of two plain lines of the right conical surface (that is, the second helical conical surface) of the internal thread and/or the external thread are opposite. A thread connection function is achieved by making the first helical conical surface of the internal thread and the first helical conical surface of the external thread be in contact and/or interference fit and/or making the second helical conical surface of the internal thread and the second helical conical surface of the external thread be in contact and/or interference fit.

In the above-mentioned symmetric bidirectional tapered thread connection pair in an olive-like shape, a head a size of which is greater than the external diameter of the columnar body is disposed at one end of the columnar body and/or one head and/two heads a size of which is less than a minor diameter of the bidirectional tapered external thread of the screw body of the columnar body are/is disposed at one end and/or two ends of the columnar body, and the connecting hole is a threaded hole provided in a nut. That is, the columnar body and the head are connected as a bolt here, a stud has no head and/or has heads at two ends a size of which is less than the minor diameter of the bidirectional tapered external thread and/or has no screw thread in the middle and has a bidirectional tapered external thread respectively at two ends, and the connecting hole is disposed within the nut.

Compared with the prior art, the symmetric bidirectional tapered thread connection pair in an olive-like shape has the following advantages of reasonable design, simple structure, convenient operation, large locking force, large load bearing capability, good anti-loosening property, high transmission efficiency and accuracy, good mechanical sealing effect and good stability, may prevent the loosening from occurring during the connection, has self-locking and self-positioning functions, and achieves fastening and connecting functions by bidirectional load bearing or sizing of the cone pair that is formed by coaxial centralizing of the internal diameter and the external diameter of the internal cone and the external cone until the sizing interference fit.

### DESCRIPTION OF THE DRAWINGS

FIG. 1 is a schematic diagram showing a structure of a connection pair for a symmetric bidirectional tapered thread in an olive-like shape according to a first embodiment of the present invention.

FIG. 2 is a schematic diagram showing a structure of a complete unit thread including an external thread and an internal thread of a connection pair for a symmetric bidirectional tapered thread in an olive-like shape according to a first embodiment of the present invention.

FIG. 3 is a schematic diagram showing a structure of a complete unit thread including an external thread and an internal thread of a connection pair for a symmetric bidirectional tapered thread in an olive-like shape according to a first embodiment of the present invention.

FIG. 4 is a schematic diagram showing a structure of a connection pair for a symmetric bidirectional tapered thread in an olive-like shape according to a second embodiment of the present invention.

FIG. 5 is a schematic diagram showing a structure of a connection pair for a symmetric bidirectional tapered thread in an olive-like shape according to a third embodiment of the present invention.

FIG. 6 is a schematic diagram showing a structure of a connection pair for a symmetric bidirectional tapered thread in an olive-like shape according to a fourth embodiment of the present invention.

FIG. 7 is a schematic diagram showing a structure of a connection pair for a symmetric bidirectional tapered thread in an olive-like shape according to a fifth embodiment of the present invention.

FIG. 8 is an illustration that “a screw thread in the existing screw thread technology is an inclined surface on a columnar surface or a conical surface” involved in the background art of the present invention.

FIG. 9 is an illustration of “an inclined surface slider model adopting the principle of the existing screw thread technology, that is, the principle of an inclined surface” involved in the background art of the present invention.

FIG. 10 is an illustration of “a thread lift angle in the existing screw thread technology” involved in the background art of the present invention.

In the figures, 1—tapered thread; 2—cylindrical body, 21—nut body, 3—columnar body; 31—screw body; 4—tapered hole; 41—bidirectional tapered hole; 42—bidirectional conical surface of the tapered hole; 421—first helical conical surface of tapered hole; α1—first taper angle; 422—second helical conical surface of tapered hole; α2—second taper angle; 5—internal helical line; 6—internal thread; 61—bidirectional tapered internal thread groove; 62—bidirectional tapered internal thread plane or arc; 7—truncated cone body; 71—bidirectional truncated cone body, 72—bidirectional conical surface of truncated cone body; 721—first helical conical surface of the truncated cone body, α1—first taper angle; 722—second helical conical surface of the truncated cone body, α2—second taper angle; 8—external helical line; 9—external thread; 91—bidirectional tapered external thread groove; 92—bidirectional tapered external thread plane or arc; 93—olive-like shape; 95—left taper; 96—right taper, 97—leftward distribution; 98—rightward distribution; 10—connection pair for thread and/or thread pair; 101—clearance; 01—cone axis; 02—thread axis; A—slider on inclined surface body; B—inclined surface body; G—gravity; G1—gravity component along inclined surface; F—friction force; φ—thread lift angle; P—equivalent friction angle; d—major diameter of traditional external thread; d1—minor diameter of traditional external thread; and d2—pitch diameter of traditional external thread.

### DETAILED DESCRIPTION OF PREFERRED EMBODIMENTS

The present invention will be further described in detail below with reference to accompanying drawings and specific embodiments.

### A First Embodiment

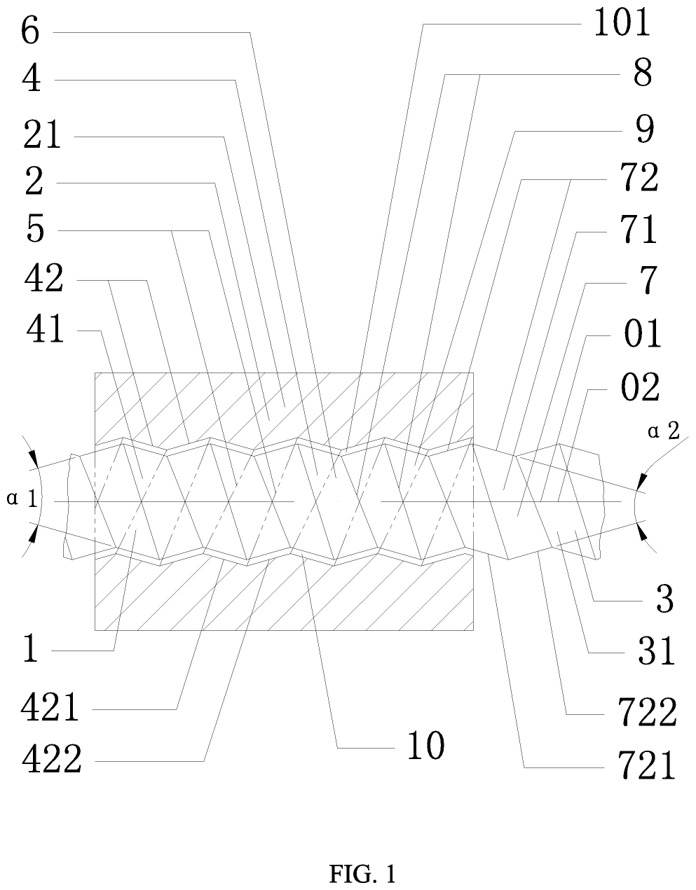

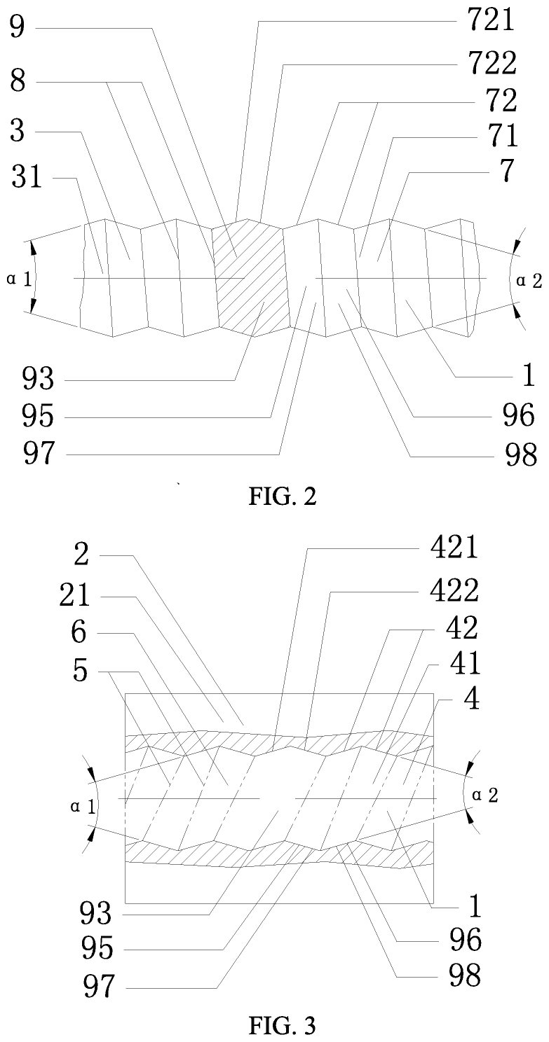

As shown in FIG. 1, FIG. 2 and FIG. 3, a connection pair for a symmetric bidirectional tapered thread in an olive-like shape includes a bidirectional truncated cone body 71 helically distributed on the external surface of the columnar body 3 and a bidirectional tapered hole 41 helically distributed on the internal surface of the cylindrical body 2, that is, an external thread 9 and an internal thread 5 in mutual thread fit, the internal thread 6 is provided with the bidirectional helical tapered hole 41 and exists in the form of a “non-entity space”, and the external thread is provided with the bidirectional helical truncated cone body 71 and exists in the form of a “material entity”. The internal thread 6 and the external thread 9 are in a relationship of a housing member and a housed member: the internal thread 6 and the external thread 9 are bidirectional tapered geometries screwed and sleeved together, and are cohered until the sizing interference fit, that is, the bidirectional tapered hole 41 houses the bidirectional truncated cone body 71 by pitches. Bidirectional housing limits a disordered degree of freedom between the tapered hole 4 and the truncated cone body 7, and the helical movement allows the connection pair 10 for the symmetric bidirectional tapered thread to obtain a necessary ordered degree of freedom. Accordingly, technical characteristics of a cone pair and a thread pair are effectively composed.

When the symmetric bidirectional tapered thread connection pair in an olive-like shape in the present embodiment is used, a bidirectional conical surface 72 of truncated cone body mutually matches with a bidirectional conical surface 42 of the tapered hole.

The connection pair 10 for the symmetric bidirectional tapered thread has self-locking and self-positioning properties as long as the truncated cone body 7 and/or the tapered hole 4 of the symmetric bidirectional tapered thread connection pair in an olive-like shape in the present embodiment reach/reaches a certain taper, that is, the cone constituting the cone pair reaches a certain taper angle. The tapers include left tapers 95 and right tapers 96, and the taper angles include left taper angles and right taper angles. The left tapers 95 correspond to the left taper angles, that is, the first taper angle α1, preferably, the first taper angle α1 is greater than 0° and less than 53°, preferably, the first taper angle α1 takes a value in a range from 2° to 40°. The right tapers 96 correspond to the right taper angles, that is, the second taper angle α2, preferably, the second taper angle α2 is greater than 0° and less than 53°, and the second taper angle α2 takes a value in a range from 2° to 40°. For individual special fields, that is, connection application fields without self-locking property and/or with poor self-positioning property and/or with high axial load bearing capacity requirement, preferably, the first taper angle α1 is greater than or equal to 53° and less than 180°, and the second taper angle α2 is greater than or equal to 53° and less than 180°.

The external thread 9 is arranged on the external surface of the columnar body 3, wherein a screw body 31 is disposed on the columnar body 3, a helically distributed truncated cone body 7 including a symmetric bidirectional truncated cone body 71 is disposed on the external surface of the screw body 31, the symmetric bidirectional truncated cone body 71 is a special bidirectional conical geometry in an olive-like shape 93, and the columnar body 3 may be solid or hollow, including cylinders, cones, pipes and the like.

The symmetric bidirectional truncated cone body 71 in an olive-like shape 93 is characterized by being formed by symmetrically and oppositely joining lower bottom surfaces of the two same truncated cone bodies, and upper top surfaces are disposed on two ends of the bidirectional truncated cone bodies 71 to form the symmetric bidirectional tapered thread 1 in an olive-like shape 93, and the process includes that the upper top surface are respectively fitted with upper top surfaces of adjacent bidirectional truncated cone bodies 71 and/or respectively fitted with upper top surfaces of adjacent bidirectional truncated cone bodies 71. The symmetric bidirectional conical surface 72 of truncated cone body is disposed on the external surface of the truncated cone body 7. The external thread 9 includes a first helical conical surface 721 of the truncated cone body, a second helical conical surface 722 of the truncated cone body, and an external helical line 8. Within a cross section passing through the thread axis 02, the complete single-pitch symmetric bidirectional tapered external thread 9 is a special bidirectional tapered geometry in an olive-like shape 93, with a large middle and two small ends, and the same and/or approximately the same size in a left taper and a right taper. An included angle between two plain lines of a left conical surface (that is, the first helical conical surface 721 of the truncated cone body) of the symmetric bidirectional truncated cone body 71 is a first taper angle α1. The left taper 95 formed by the first helical conical surface 721 of the truncated cone body corresponds to the first taper angle α1 and is in a leftward distribution 97. An included angle α2 between two plain lines of a right conical surface (that is, the second helical conical surface 722 of the truncated cone body) of the bidirectional truncated cone body 71 is a second taper angle α2. The right taper formed by the second helical conical surface 722 of the truncated cone body corresponds to the second taper angle α2 and is in a rightward distribution 98. Taper directions corresponding to the first taper angle α1 and the second taper angle α2 are opposite, and the plain lines are intersecting lines of the conical surface with the plane passing through the cone axis 01. A shape formed by the first helical conical surface 721 of the truncated cone body and the second helical conical surface 722 of the truncated cone body of the bidirectional truncated cone body 71 is the same as a shape of an external helical lateral surface of a rotary body, wherein the rotary body is formed by two inclined sides of a right-angled trapezoid union when the right-angled trapezoid union axially moves at a constant speed along a central axis of the columnar body 3 while circumferentially rotating at a constant speed with right-angled sides of the right-angled trapezoid union as a rotation center, wherein the right-angled trapezoid union is formed by symmetrically and oppositely joining lower bottom sides of two same right-angled trapezoids, wherein the right-angled trapezoids coincide with the central axis of the columnar body 3. The right-angled trapezoid union refers to a special geometry in which the lower bottom sides of the two same right-angled trapezoids are symmetrically and oppositely joined and the upper bottom sides thereof are respectively located at two ends of the right-angled trapezoid union.

The internal thread 6 is arranged on the internal surface of the cylindrical body 2, wherein the cylindrical body 2 is provided with a nut body 21, a helically distributed tapered hole 4 including a symmetric bidirectional tapered hole 41 is provided in the nut body 21, the symmetric bidirectional tapered hole 41 is a special bidirectional conical geometry in an olive-like shape 93, and the cylindrical body 2 includes cylindrical workpieces and objects and/or non-cylindrical workpieces and objects that need to be machined with internal threads on their internal surfaces.

The symmetric bidirectional tapered hole 41 in an olive-like shape 93 is characterized by being formed by symmetrically and oppositely joining lower bottom surfaces of the two same tapered holes, and upper top surfaces are disposed on two ends of the bidirectional tapered hole 41 to form the symmetric bidirectional tapered thread 1 in an olive-like shape 93, and the process includes that the upper top surfaces are respectively fitted with upper top surfaces of adjacent bidirectional tapered holes 41 and/or respectively fitted with upper top surfaces of adjacent bidirectional tapered holes 41. The tapered hole 4 includes a symmetric bidirectional tapered hoe conical surface 42. The internal thread 6 includes a first helical conical surface 421 of the tapered hole, a second helical conical surface 422 of the tapered hole, and an internal helical line 5. Within a cross section passing through the thread axis 02, the complete single-pitch symmetric bidirectional tapered internal thread 6 is a special bidirectional tapered geometry in an olive-like shape 93, with a large middle and two small ends, and the same and/or approximately the same size in a left taper and a right taper, wherein an included angle between two plain lines of a left conical surface (that is, the first helical conical surface 421 of the tapered hole) of the bidirectional tapered hole 41 is a first taper angle α1, and the left taper 95 formed by the first helical conical surface 421 of the tapered hole corresponds to the first taper angle α1 and is in a leftward distribution 97; and an included angle α2 between two plain lines of a right conical surface (that is, the second helical conical surface 422 of the tapered hole) of the bidirectional tapered hole 41 is a second taper angle α2, and the right taper 96 formed by the second helical conical surface 422 of the tapered hole corresponds to the second taper angle α2 and is in a rightward distribution 98. Taper directions corresponding to the first taper angle α1 and the second taper angle α2 are opposite, and the plain lines are intersecting lines of the conical surface with the plane passing through the cone axis 01. A shape formed by the first helical conical surface 421 of the tapered hole and the second helical conical surface 422 of the tapered hole of the bidirectional tapered hole 41 is the same as a shape of an external helical lateral surface of a rotary body, wherein the rotary body is formed by two inclined sides of a right-angled trapezoid union when the right-angled trapezoid union axially moves at a constant speed along a central axis of the cylindrical body 2 while circumferentially rotating at a constant speed with right-angled sides of the right-angled trapezoid union as a rotation center, wherein the right-angled trapezoid union is formed by symmetrically and oppositely joining lower bottom sides of two same right-angled trapezoids, wherein the right-angled trapezoids coincide with the central axis of the cylindrical body 2. The right-angled trapezoid union refers to a special geometry in which the lower bottom sides of the two same right-angled trapezoids are symmetrically and oppositely joined and the upper bottom sides thereof are respectively located at two ends of the right-angled trapezoid union.

In the above-mentioned symmetric bidirectional tapered thread connection pair in an olive-like shape, there are connection forms such as sharp corners and/or non-sharp corners at the junction of two adjacent helical conical surfaces of the external thread 9 and the junction of two adjacent helical conical surfaces of the internal thread 6. The sharp corners refer to structural forms without being specially treated with the non-sharp corners relative to the non-sharp corners.

The above-mentioned symmetric bidirectional tapered thread connection pair 71 in an olive-like shape 93 and the bidirectional tapered hole 41 are characterized in that the external sharp corner is adopted as the connection form at the junction between the first helical conical surface 721 of the truncated cone body and the truncated cone body second helical conical surface 722 of the bidirectional truncated cone body 71 of the same helix, that is, at a major diameter of the external thread 9, and an external helical line 8 helically distributed is formed. The internal sharp corner is adopted as the connection form at the junction between the first helical conical surface 721 of the truncated cone body of the bidirectional truncated cone body 71 and the second helical conical surface 722 of the truncated cone body of an adjacent bidirectional truncated cone body 71 of the same helix and/or the junction between the second helical conical surface 722 of the truncated cone body of the bidirectional truncated cone body 71 and the first helical conical surface 721 of the truncated cone body of an adjacent bidirectional truncated cone body 71 of the same helix, that is, at a minor diameter of the external thread 9, and an external helical line 8 helically distributed is formed. The internal sharp corner is adopted as the connection form at the junction between the first helical conical surface 421 of the tapered hole and the second helical conical surface 422 of the tapered hole of the bidirectional tapered hole 41 of the same helix, that is, at a major diameter of the internal thread 6, and an internal helical line 5 helically distributed is formed. The external sharp corner is adopted as the connection form at a junction between the first helical conical surface 421 of the tapered hole of the bidirectional tapered hole 41 and the second helical conical surface 422 of the tapered hole of an adjacent bidirectional tapered hole 41 of the same helix and/or the junction between the second helical conical surface 422 of the tapered hole of the bidirectional tapered hole 41 and the first helical conical surface 421 of the tapered hole of an adjacent bidirectional tapered hole 41 of the same helix, that is, at a minor diameter of the internal thread 6, and an internal helical line 5 helically distributed is formed. The tapered thread 1 is compact in structure, relatively high in strength and large in load bearing capability, and has good mechanical connecting, locking and sealing performances, and relatively large physical space for the tapered thread machining.

When the symmetric bidirectional tapered thread connection pair in an olive-like shape is in transmission connection, bidirectional load bearing is achieved by the screw connection of the bidirectional tapered hole 41 and the bidirectional truncated cone body 71. When the external thread 9 and the internal thread 6 form a thread pair 10, there must be a clearance 101 between the internal thread 6 and the external thread 9, that is, there must be a clearance 101 between the bidirectional truncated cone body 71 and the bidirectional tapered hole 41. If there is oil and other mediums for lubrication between the internal thread 6 and the external thread 9, it will easily form a load bearing oil film. The clearance 101 is conducive to the formation of the load bearing oil film. The connection pair 10 for the symmetric bidirectional tapered thread is equivalent to a group of sliding bearing pairs composed of one pair and/or several pairs of sliding bearings, that is, each pitch of the bidirectional tapered internal thread 6 bidirectionally houses the corresponding pitch of the bidirectional tapered external thread 9 to form a pair of sliding bearings, the number of the sliding bearings formed is adjusted according to the application conditions, that is, the number of the pitches of the housing screw threads and the housed screw threads for the effective bidirectional joint, that is, the effective bidirectional contact cohesion, of the bidirectional tapered internal thread 6 and the bidirectional tapered external thread 9 is designed according to the application conditions. Through bidirectional housing of the bidirectional internal cone 6 for the bidirectional external cone 9 and positioning in multiple directions such as radial, axial, angular, and circumferential directions, a special composition technology of the cone pair and the thread pair is constituted, so as to ensure the transmission connecting accuracy, efficiency and reliability of the tapered thread technology, especially the connection pair 10 for the symmetric bidirectional tapered thread.

When the symmetric bidirectional tapered thread connection pair in an olive-like shape in the present embodiment is in fastened and sealed connections, technical performances such as connecting performance, locking capability, anti-loosening property, load bearing capability, fatigue resistance and sealing property are achieved by the screw connection of the bidirectional tapered hole 41 and the bidirectional truncated cone body 71, that is, the first helical conical surface 721 of the truncated cone body and the first helical conical surface 421 of the tapered hole are sized until the interference and/or the second helical conical surface 722 of the truncated cone body and the second helical conical surface 422 of the tapered hole are sized until the interference. Load bearing in one direction and/or in two directions simultaneously are/is achieved according to the application conditions, that is, the bidirectional truncated cone body 71 and the bidirectional tapered hole 41 achieve that internal and external diameters of the internal cone and the external cone are centralized under the guidance of the helical line until the first helical conical surface 421 of the tapered hole and the first helical conical surface 721 of the truncated cone body are cohered until the interference contact and/or the second helical conical surface 422 of the tapered hole and the second helical conical surface 722 of the truncated cone body are cohered until the interference contact, thereby achieving technical performances such as connecting performance, locking capability, anti-loosening property, load bearing capability, fatigue resistance and sealing property of a mechanical fastening structure.

Accordingly, the technical performances such as transmission accuracy and efficiency, load bearing capability, self-locking force, anti-loosening capability, sealing performance and reusability of the symmetric bidirectional tapered thread connection pair in an olive-like shape are related to the first helical conical surface 721 of the truncated cone body and the left taper 95 (that is, the first taper angle α1) formed therefrom and the second helical conical surface 722 of the truncated cone body and the right taper 96 (that is, the second taper angle α2) formed therefrom as well as the first helical conical surface 421 of the tapered hole and the left taper formed 95 (that is, the first taper angle α1) formed therefrom and the second helical conical surface 422 of the tapered hole and the right taper 96 (that is, the second taper angle 2) formed therefrom. The friction coefficient, the processing quality and the application conditions of a material of which the columnar body 3 and the cylindrical body 2 are made have a certain influence on the cone fit.

In the above-mentioned symmetric bidirectional tapered thread connection pair in an olive-like shape, when the right-angled trapezoid union makes one revolution at a constant speed, a distance that the right-angled trapezoid union axially moves is equal to at least one times the sum of lengths of right-angled sides of the two same right-angled trapezoids. This structure ensures that the first helical conical surface 721 of the truncated cone body and the second helical conical surface 722 of the truncated cone body as well as the first helical conical surface 421 of the tapered hole and the second helical conical surface 422 of the tapered hole are enough in length, thereby ensuring enough effective contact area and strength when the bidirectional conical surface 72 of truncated cone body matches with the bidirectional conical surface 42 of the tapered hole, as well as the efficiency required for the helical movement.

In the above-mentioned symmetric bidirectional tapered thread connection pair in an olive-like shape, when the right-angled trapezoid union makes one revolution at a constant speed, a distance that the right-angled trapezoid union axially moves is equal to the sum of lengths of right-angled sides of the two same right-angled trapezoids. This structure ensures that the first helical conical surface 721 of the truncated cone body and the second helical conical surface 722 of the truncated cone body as well as the first helical conical surface 421 of the tapered hole and the second helical conical surface 422 of the tapered hole are enough in length, thereby ensuring enough effective contact area and strength when the bidirectional conical surface 72 of truncated cone body matches with the bidirectional conical surface 42 of the tapered hole, as well as the efficiency required for the helical movement.

In the above-mentioned symmetric bidirectional tapered thread connection pair in an olive-like shape, the first helical conical surface 721 of the truncated cone body and the second helical conical surface 722 of the truncated cone body are both continuous helical surfaces or non-continuous helical surfaces. The first helical conical surface 421 of the tapered hole and the second helical conical surface 422 of the tapered hole are both continuous helical surfaces or non-continuous helical surfaces. Preferably, the first helical conical surface 721 of the truncated cone body and the second helical conical surface 722 of the truncated cone body as well as the first helical conical surface 421 of the tapered hole and the second helical conical surface 422 of the tapered hole here are all continuous helical surfaces.

In the above-mentioned symmetric bidirectional tapered thread connection pair in an olive-like shape, one end and/or two ends of the columnar body 3 may be one or two screwing ends screwed into a connecting hole of the cylindrical body 2.

In the above-mentioned symmetric bidirectional tapered thread connection pair in an olive-like shape, a head a size of which is greater than the external diameter of the columnar body 3 is disposed at one end of the columnar body 3 and/or one head and/or two heads a size of which is less than a minor diameter of the bidirectional tapered external thread 9 of a screw body 31 of the columnar body 3 are/is disposed at one end and/or two ends of the columnar body 3, and the connecting hole is a threaded hole provided in a nut 1. That is, the columnar body 3 and the head are connected as a bolt here, and a stud has no head and/or has heads a size of which is less than the minor diameter of the bidirectional tapered external thread 9 at two ends and/or has no screw thread in the middle and has a bidirectional tapered external thread 9 respectively at two ends.

Compared with the prior art, the symmetric bidirectional tapered thread connection pair in an olive-like shape has the following advantages of reasonable design, simple structure, convenient operation, large locking force, large load bearing capability, good anti-loosening property, high transmission efficiency and accuracy, good mechanical sealing effect and good stability, may prevent the loosening from occurring during the connection, has self-locking and self-positioning functions, and achieves fastening and connecting functions by sizing the diameter of the cone pair formed by the internal cone and the external cone until the interference fit.

### A Second Embodiment

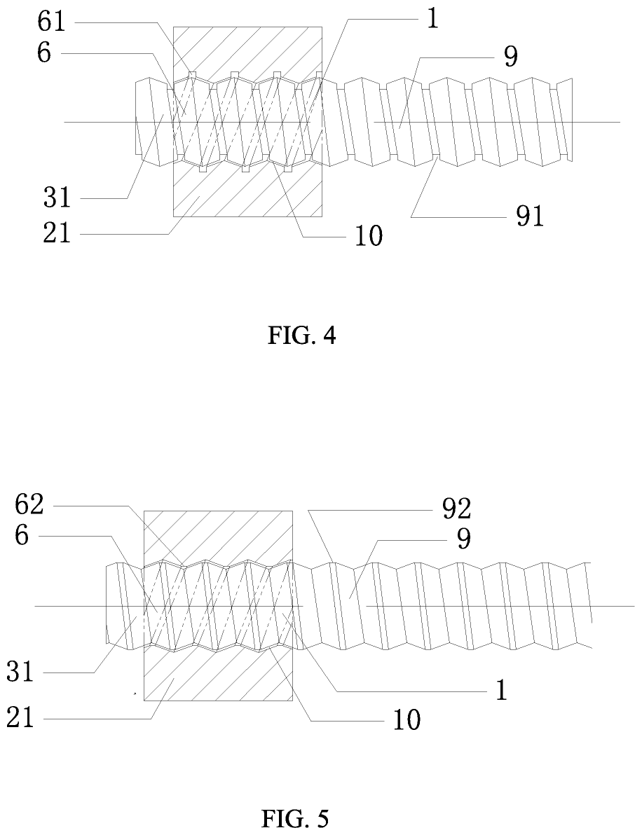

As shown in FIG. 4, the structure, principle, and implementation steps of the present embodiment are similar to those of the first embodiment, except that an external helical structure connected by a groove 91 is adopted at the minor diameter of the external thread 9, that is, at a junction of adjacent helical conical surfaces. The external helical structure is a special external helical line 8. An internal helical structure connected by a groove 61 is adopted at the major diameter of the internal thread 6. The internal helical structure is a special internal helical line 5. The interference may be prevented from occurring when the internal thread 6 and the external thread 9 are screwed together. Oil and dirt may be stored as well.

### A Third Embodiment

As shown in FIG. 5, the structure, principle, and implementation steps of the present embodiment are similar to those of the first embodiment, except that an external helical structure connected by a plane or arc 92 is adopted at the major diameter of the external thread 9. The external helical structure is a special external helical line 8. An internal helical structure connected by a plane or arc 62 is adopted at the minor diameter of the internal thread 6, that is, a junction of adjacent helical conical surfaces. The internal helical structure is a special internal helical line 5. The interference may be prevented from occurring when the internal thread 6 and the external thread 9 are screwed together. Oil and dirt may be stored as well.

### A Fourth Embodiment

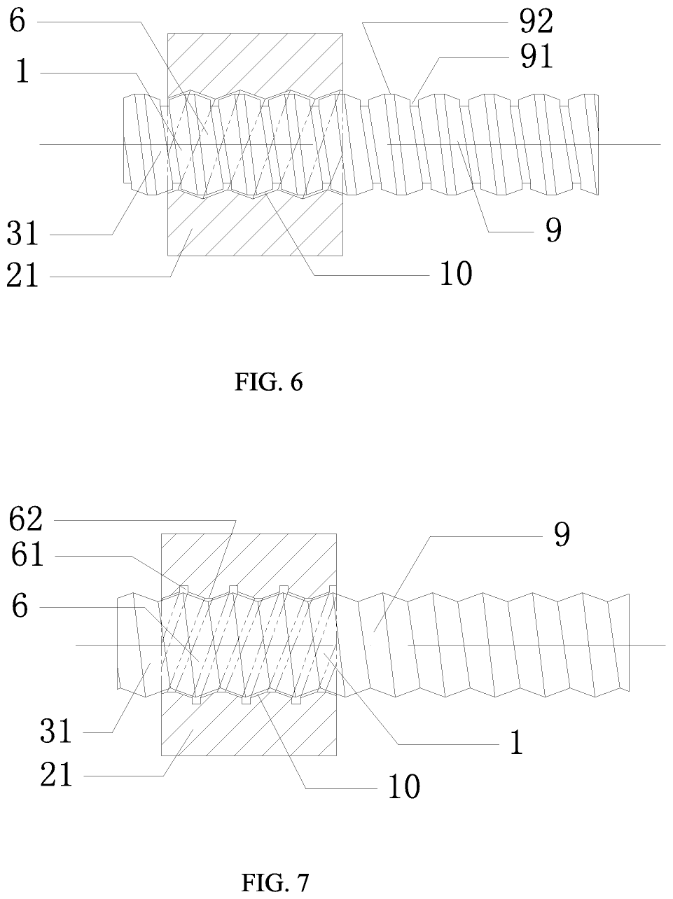

As shown in FIG. 6, the structure, principle and implementation steps of this embodiment are similar to those of the first embodiment, except that an external helical structure connected by a groove 91 is adopted at the minor diameter of the external thread 9, that is, at a junction of adjacent helical conical surfaces. An external helical structure connected by a plane or arc 92 is adopted at the major diameter of the external thread 9. The external helical structure is a special external helical line 8. The minor diameter and the major diameter of the internal thread 6 forming a thread pair 10 together with the external thread 9 are connected by adopting a sharp corner. An R corner possibly existing when the thread pair 10 is formed may be avoided, the interference may be prevented from occurring when the internal thread 6 and the external thread 9 are screwed together. Oil and dirt may be stored as well.

### A Fifth Embodiment

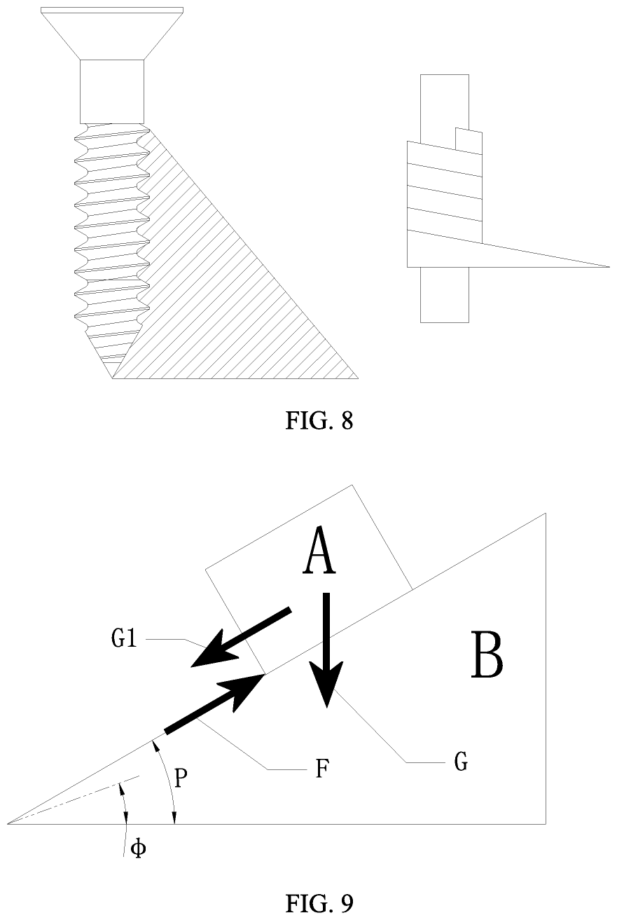

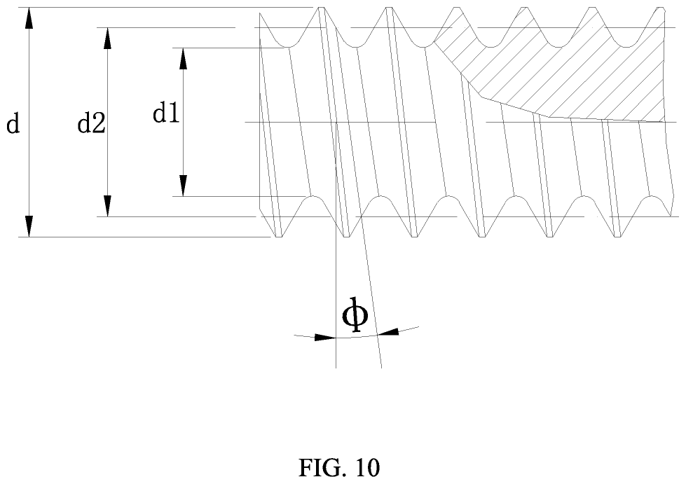

As shown in FIG. 7, the structure, principle and implementation steps of this embodiment are similar to those of the first embodiment, except that an internal helical structure connected by a groove 61 is adopted at the major diameter of the internal thread 6, and an internal helical structure connected by a plane or arc 62 is adopted at a minor diameter of the internal thread 6, that is, at a junction of adjacent helical conical surfaces. The internal helical structure is a special internal helical line 5. The minor diameter and the major diameter of the external thread 9 forming a thread pair 10 together with the internal thread 6 are connected by adopting a sharp corner. An R corner possibly existing when the thread pair 10 is formed may be avoided, the interference may be prevented from occurring when the internal thread 6 and the external thread 9 are screwed together. Oil and dirt may be stored as well.

Specific embodiments described herein are exemplary illustrations to the spirit of the present invention. Those skilled in the art to which the present invention pertains may make various modifications or additions to the specific embodiments described or obtain equivalents by using similar alternatives without deviating from the spirit of the present invention or exceeding the scope defined by the appended claims.

Although terms such as tapered thread 1, cylindrical body 2, nut body 21, columnar body 3, screw body 31, tapered hole 4, bidirectional tapered hole 41, bidirectional conical surface 42 of the tapered hole, first helical conical surface 421 of the tapered hole, first taper angle α1, second helical conical surface 422 of the tapered hole, second taper angle α2, internal helical line 5, internal thread 6, bidirectional tapered internal thread groove 61, bidirectional tapered internal thread plane or arc 62, truncated cone body 7, bidirectional truncated cone body 71, bidirectional conical surface 72 of truncated cone body, first helical conical surface 721 of the truncated cone body, first taper angle α1, second helical conical surface 722 of the truncated cone body, second taper angle α2, external helical line 8, external thread 9, bidirectional tapered external thread groove 91, bidirectional tapered external thread plane or arc 92, olive-like shape 93, left taper 95, right taper 96, leftward distribution 97, rightward distribution 98, connection pair for thread and/or thread pair 10, clearance 101, self-locking force, self-locking, self-positioning, pressure, cone axis 01, thread axis 02, mirror image, shaft sleeve, shaft, non-entity space, material entity, unidirectional tapered body, bidirectional tapered body, cone, internal cone, tapered hole, external cone, cone, cone pair, helical structure, helical movement, thread body, complete unit thread, concentric force, concentric force angle, anti-concentric force, anti-concentric force angle, centripetal force, anti-centripetal force, reverse collinear, internal stress, bidirectional force, unidirectional force, sliding bearing, sliding bearing pair and so on have been widely used in the present invention, other terms can be used alternatively. These terms are only used to better description and illustration of the essence of the present invention. It departs from the spirit of the present invention to deem it as any limitation of the present invention.

We claim:

1. A connection pair for a symmetric bidirectional tapered thread in an olive-like shape, comprising an internal thread (9) and an internal thread (6) in mutual thread fit, wherein a complete unit thread of the symmetric bidirectional tapered thread (1) in an olive-like shape (93) is a symmetric bidirectional helical tapered body having an olive-like (93), with a large middle and two small ends;
the symmetric bidirectional helical cone in an olive-like shape (93) comprises a bidirectional tapered hole (41) and/or a bidirectional truncated cone body (71);
a thread body of the internal thread (6) is provided with the bidirectional tapered helical hole (41) in an internal surface of a cylindrical body (2) and exists in the form of a “non-entity space”, and a thread body of the external thread (9) is provided with the bidirectional helical truncated cone body (71) in an external surface of a columnar body (3) and exists in the form of a “material entity”;
a left taper (95) formed by a left conical surface of the asymmetric bidirectional tapered body corresponds to a first taper angle α1, a right taper (96) formed by a right conical surface corresponds to a second taper angle α2;
directions of the left taper (95) and the right taper (96) are opposite and the left taper (95) and the right taper (96) are identical and/or approximately identical;
the internal thread (6) and the external thread (9) house the cone via the tapered hole until the internal conical surface and the external conical surface mutually bear; and
technical performances mainly depend on the conical surfaces and the tapers of the screw thread bodies in mutual fit, preferably, the first taper angle α1 is greater than 0° and less than 53°, the second taper angle α2 is greater than 0° and less than 53°, preferably, the first taper angle α1 is greater than or equal to 53′ and less than 180°, and the second taper angle α2 is greater than or equal to 53° and less than 180°.

2. The symmetric bidirectional tapered thread connection pair according to claim 1, wherein
the bidirectional tapered internal thread (6) in an olive-like shape (93) comprises a left conical surface, that is, a first helical conical surface (421) of the tapered hole, and a right conical surface, that is, a second helical conical surface (422) of the tapered hole of a bidirectional conical surface (42) of the tapered hole, and an internal helical line (5);
a shape formed by the first helical conical surface (421) of the tapered hole and the second helical conical surface (422) of the tapered hole, that is, a bidirectional helical conical surface, is the same as a shape of an external helical lateral surface of a rotary body, wherein the rotary body is formed by two inclined sides of a right-angled trapezoid union when the right-angled trapezoid union axially moves at a constant speed along a central axis of the columnar body (3) while circumferentially rotating at a constant speed with right-angled sides of the right-angled trapezoid union as a rotation center, wherein the right-angled trapezoid union is formed by symmetrically and oppositely joining lower bottom sides of two same right-angled trapezoids, wherein the right-angled trapezoids coincide with the central axis of the columnar body (3);
the bidirectional tapered external thread (9) in an olive-like shape (93) comprises a left conical surface, that is, a first helical conical surface (721) of the truncated cone body, and a right conical surface, that is, a second helical conical surface (722) of the truncated cone body of a bidirectional conical surface (72) of truncated cone body, and an external helical line (8); and
a shape formed by the first helical conical surface (721) of the truncated cone body and the second helical conical surface (722) of the truncated cone body, that is, a bidirectional helical conical surface, is the same a shape of an external helical surface of a rotary body formed by two inclined sides of a right-angled trapezoid union when the right-angled trapezoid union axially moves at a constant speed along the central axis of the columnar body (3) while circumferentially rotating at a constant speed with right-angled sides of the right-angled trapezoid union, which are symmetrically and oppositely joined with lower bottom sides of the two same right-angled trapezoids that coincide with the central axis of the columnar body (3), as a rotation center.

3. The symmetric bidirectional tapered thread connection pair according to claim 2, wherein when the right-angled trapezoid union makes one revolution at a constant speed, a distance that the right-angled trapezoid union axially moves is equal to at least one times the sum of lengths of right-angled sides of the two same right-angled trapezoids.

4. The symmetric bidirectional tapered thread connection pair according to claim 2, wherein when the right-angled trapezoid union makes one revolution at a constant speed, a distance that the right-angled trapezoid union axially moves is equal to the sum of lengths of right-angled sides of the two same right-angled trapezoids.

5. The symmetric bidirectional tapered thread connection pair according to claim 1, wherein the left conical surface and the right conical surface, that is, the first helical conical surface (421) of the tapered hole and the second helical conical surface (422) of the tapered hole, of the bidirectional tapered body as well as the internal helical line (5) are all continuous helical surfaces or non-continuous helical surfaces and/or the first helical conical surface (721) of the truncated cone body and the second helical conical surface (722) of the truncated cone body as well as the external helical line (8) are all continuous helical surfaces or non-continuous helical surfaces.

6. The symmetric bidirectional tapered thread connection pair according to claim 1, wherein
the internal thread (6) is formed by symmetrically and oppositely joining lower bottom surfaces of the two same tapered holes (4), and upper top surfaces are disposed on two ends of the bidirectional tapered holes (41) to form the symmetric bidirectional tapered thread (1) in an olive-like shape (93), and the process comprises that the upper top surfaces are respectively fitted with upper top surfaces of adjacent bidirectional tapered holes (41) and/or respectively fitted with upper top surfaces of adjacent bidirectional tapered holes (41) in a helical form so as to form the symmetric bidirectional internal thread (6) in an olive-like shape (93); and
the external thread (9) is formed by symmetrically and oppositely joining the lower bottom surfaces of the two same truncated cone bodies (7), and upper top surfaces are disposed on two ends of the bidirectional truncated cone body (71) to form the symmetric bidirectional tapered thread (1) in an olive-like shape (93), and the process includes that the upper top surfaces are respectively fitted with upper top surfaces of adjacent bidirectional truncated cone bodies (71) and/or respectively fitted with upper top surfaces of adjacent bidirectional truncated cone bodies (71) in a helical form so as to form the symmetric bidirectional external thread (9) in an olive-like shape (93).

7. The symmetric bidirectional tapered thread connection pair according to claim 1, wherein
an external sharp corner structure is adopted as a connection form at a major diameter of the external thread (9), an internal sharp corner structure is adopted as a connection form at a minor diameter of the external thread (9), an internal sharp corner structure is adopted as a connection form at a major diameter of the internal thread (6), an external sharp corner structure is adopted as a connection form at a minor diameter of the internal thread (6) and/or a groove (91) is adopted for the minor diameter of the external thread (9), a groove (61) structure is adopted as a connection form at the major diameter of the internal thread (6), a sharp corner structure is maintained as a connection form at the major diameter of the external thread (9) and the minor diameter of the internal thread (6) and/or a plane or arc (92) structure is adopted as a connection form at the major diameter of the external thread (9), a plane or arc (62) structure is adopted as a connection form at the minor diameter of the internal thread (6), a sharp corner structure is maintained as a connection form at the minor diameter of the external thread (9) and the major diameter of the internal thread (6) and/or a groove (91) structure is adopted as a connection form at the minor diameter of the external thread (9), a groove (61) structure is adopted as a connection form at the major diameter of the internal thread (6), a plane or arc (92) structure is adopted as a connection form at the major diameter of the internal thread (6), and a plane or arc (62) structure is adopted as a connection form at the minor diameter of the internal thread (6).

8. The symmetric bidirectional tapered thread connection pair according to claim 1, wherein
the internal thread (6) and the external thread (9) form the thread pair (10) in such a way that a helical bidirectional tapered hole (41) and a helical bidirectional truncated cone body (71) are mutually sized and cooperated under the guidance of the helical line to form the cone pair with multiple pitches, and there is a clearance (101) between the bidirectional truncated cone body (71) and the bidirectional tapered hole (41);
each pitch of the internal thread (6) houses a corresponding pitch of the external thread (9) and they are coaxially centralized and sized to form a pair of sliding bearings, the entire thread connection pair (10) is composed of one pair or several pairs of sliding bearings, the number of the pitches of the housing screw threads and the housed screw threads for the effective bidirectional joint, that is, the effective bidirectional contact cohesion, of the internal thread (6) and the external thread (9) is designed according to the application conditions; and
the tapered hole (4) of the internal thread (6) bidirectionally houses the truncated cone body (7) of the external thread (9) and they are positioned in multiple directions such as radial and circumferential, axial and angular directions, each pitch of the internal thread (6) and each pitch of the external thread (9) comprise one-side bidirectional load bearing and/or left and right bidirectional load bearing.

9. The symmetric bidirectional tapered thread connection pair according to claim 1, wherein
the internal thread (6) and the external thread (9) form the thread pair (10) in such a way that a first helical conical surface (421) of the tapered hole and a second helical conical surface (422) of the tapered hole as well as a first helical conical surface (721) of the truncated cone body and a second helical conical surface (722) of the truncated cone body which are mutually cooperated, that is, the internal diameters and the external diameters of the internal cone and the external cone, are sized by taking a contact surface as a bearing surface under the guidance of the helical line until the bidirectional conical surface (42) of the tapered hole and the bidirectional conical surface (72) of truncated cone body are cohered to achieve the load bearing in one direction of the helical conical surface and/or the load bearing in both directions of the helical conical surface and/or until the sizing self-positioning contact and/or until the sizing interference contact to achieve self-locking.

10. The symmetric bidirectional tapered thread connection pair according to claim 1, wherein the columnar body (3) may be solid or hollow, comprising columnar workpieces and objects and/or non-columnar workpieces and objects that need to be machined with screw threads on their external surfaces, and the cylindrical body (2) comprises cylindrical workpieces and objects and/or non-cylindrical workpieces and objects that need to be machined with screw threads on their external surfaces, and the external surfaces and the internal surfaces comprise columnar surfaces, non-columnar surfaces such as conical surfaces, and internal surfaces of other geometric shapes.

11. The symmetric bidirectional tapered thread connection pair according to claim 1, wherein the internal thread (6) and/or the external thread (9) comprise/comprises a single-pitch screw thread is an incomplete conical geometry, that is, the single-pitch screw thread is an incomplete unit thread.
